(19) United States
(12) Patent Application Publication
(10) Pub. No.: US 2007/0059463 A1
(43) Pub. Date: Mar. 15, 2007

(54) Apparatus and method for the production of a multi-component extrusion with capstock coating including snap-in connector and product so produced

(76) Inventors: George Melkonian, Federal Way, WA (US); Douglas L. Cole, Seattle, WA (US)

Correspondence Address: Mikron Industries, Inc.;ATTN: David C. Gadd, 1034 Sixth Avenue North, Kent, WA, 98032, US

(21) Appl. No.: 11/602,041

(22) Filed: Nov. 20, 2006

Related U.S. Application Data
(63) Continuation of application No. 10/691,124, filed on Oct. 21, 2003, now abandoned.
(60) Provisional application No. 60/420,484, filed on Oct. 21, 2002.

(51) Int. Cl. B29C 44/24; B29C 47/06; B31B 45/00; B32B 3/06

(52) U.S. Cl. 428/34.1; 264/167; 264/173.17; 264/45.9; 428/99

(57) ABSTRACT

An apparatus and method for the production of a multi-component extrusion having at least one snap-in connector prong attached to a capstocking layer and the multi-component extrusion so produced is disclosed. The multi-component extrusion is preferably produced in a multi-plate extrusion die where a primary extrudate is formed, a base capstocking layer is formed of a capstocking extrudate and is applied to a prong mounting surface of the primary extrudate, and the prong is formed of the capstocking extrudate and is attached to the base capstocking layer.

This application claims priority of the filing date of co-pending U.S. Utility application Ser. No. 10/691,124 which claimed the priority of U.S. Provisional Patent Application Ser. No. 60/420,484.

### TECHNICAL FIELD

This invention relates to methods and apparatus for forming a multi-component extrusion and the multi-component extrusion so produced. More specifically the invention relates to methods and apparatus for forming a snap-connector from a capstock material that is co-extruded with an extruded profile formed from a different extrudable material.

### BACKGROUND OF THE INVENTION

Milled wood products have formed the foundation for the fenestration, decking, venetian blinds, shutters, decking and remodeling industries for many years. Historically, ponderosa pine, fir, red wood, cedar and other coniferous varieties of soft woods have been employed with respect to the manufacture of residential window frames, residential siding, outer decking and exterior shutters as well as interior venetian blinds and shutters. Wood products of this type inherently possess the advantageous characteristics of high flexural modulus, good screw retention, easy workability (e.g., milling, cutting, paintability), and for many years, low cost. Conversely, wood products of this type have also suffered from poor weatherability in harsh climates potential insect infestation such as by termites, and high thermal conductivity. In addition, virgin wood resources have become scarce causing correspondingly high material costs.

In response to the above described disadvantages of milled wood products, the fenestration industry, in particular, adopted polyvinyl chloride (PVC) as a raw material. Hollow, lineal extrusions manufactured into window frames became an enormous success, particularly at the lower end of the price spectrum. The window frames made from hollow PVC lineals have exhibited superior thermal conductivity, water absorption resistance, rot and insect resistance, and ultraviolet radiation resistance compared to painted ponderosa pine. Although such extrusions further enjoyed a significant cost advantage over comparable milled wood products, these PVC products had a significantly lower flexural modulus and higher coefficient of thermal expansion and were difficult to paint effectively.

By the mid-1990's, a number of window and door frame manufacturers attempted to combine the most desirable characteristics of extruded thermoplastic polymers and solid wood frame members by alloying PVC with wood flour or other fillers. Further, many manufacturers have produced solid (i.e., non-hollow) lineal extrusions typically either out of a foamed PVC and wood alloy or of a foamed PVC (or another thermoplastic resin). Both of these solutions can increase the strength of the profile while keeping the overall cost of the extrude lineal as low as practicable. In any of these cases, the foamed or wood composite lineal extrusion will typically need to be capstocked with a weather-proof thermoplastic coating or else the lineals will need to be painted. The preferred practice is to capstock the lineal by co-extruding a thin layer of PVC resin or other weatherable thermoplastic that includes various ultraviolet radiation inhibitors to provide a smooth, aesthetically pleasing, durable exterior surface. The capstock material is fed into the extrusion die by a separate capstock extruder and the capstock material is typically fed around the foamed or composite extrusion profile and is held in place against the foamed or composite profile by the extrusion die walls. The capstock material flows around and takes its shape substantially from the shape of the foamed or composite extrusion profile. The pressure provided by the capstocking extruder forces the capstock material into the die and the capstock material flows around the exterior of the foamed or composite extrusion profile.

The use of hollow thin wall extruded profiles allowed changes to the way the window frames were connected to various window frame accessories such as glazing beads, stucco beads or even nail fins. One convenient method allowed by the extrusion process is the “snap-in” connector. The snap-in connector has a male prong or prongs which jut out from a side of an extruded profile and typically extend the length of such an extruded profile. The prongs compress when inserted into a female snap-in connector slot which extends the length of another profile. These male prongs are relatively easily added to a hollow wall extrusion as the prongs can be extruded from the same material, typically PVC resin, that is used for both the walls and the prongs of the extruded profile. The thickness of the prongs are relatively comparable to the thickness of the walls of the extruded profile allowing the extrusion die to feed both the prongs and the main walls without significant difficulties.

In a multi-component extrusion where the interior portion of the extruded profile is a foamed thermoplastic resin, a foamed thermoplastic resin and wood flour composite, or a non-foamed thermoplastic resin and wood flour composite, this interior compound is not suitable for extruding into the thin elongated prongs required for the male portion of the snap-in connector. The prior art practice that applies a capstock material to the extrusion profile and uses the existing profile to shape and force the thin layer of capstock material against the walls of the extrusion die is unable to produce the prongs of the male connector. The prior art die designed to supply a thin capstock layer to the exterior of a profile is unable to supply enough capstock material to form the relatively thick and extended prongs required for the prong or prongs of a snap-in connector. Using prior art processes, the prongs of the snap-in connector will not fill in properly with capstock material in a production setting.

### SUMMARY OF THE INVENTION

One embodiment of the invention disclosed herein is a multi-plate extrusion die of the type having upstream and downstream directions, and includes a primary aperture for passage through the die of a primary extrudate. The primary aperture extends longitudinally through the die and the primary extrudate is formed into a profile having a prong mounting face by the primary aperture. A base capstock conduit feeds a capstock extrudate, where the base capstock conduit joins with the primary aperture and applies a base capstock coating of the capstock extrudate on the prong mounting face of the primary extrudate. A prong capstocking conduit feeds the capstock extrudate, forms at least one prong, and meets with the base capstocking aperture downstream of where the base capstocking aperture meets the primary aperture containing the primary extrudate. Therefore, the prong is attached to the base capstock coating on the mounting face of the primary extrudate.

A further embodiment of the invention is a method for forming a multi-component extrusion having snap-in connectors, which includes forming a primary extrusion profile from a primary extrudate where the primary extrusion profile has a mounting face, forming a base capstock layer from a capstock extrudate on at least the mounting face of the primary extrusion profile, and then forming a capstock prong from a capstock extrudate and attaching the capstock prong to the base capstock layer. Thus a final extrusion profile is co-extruded whereby the primary extrusion profile, the base capstock layer and the capstock prong are joined in a molten, plastic state and where the prong formed from a capstock material is attached to the base capstock layer also formed from the capstock material where the base capstock layer is already applied to the primary extrusion profile formed of the primary extrudate.

A still further embodiment of the invention is a multi-component extrusion having at least one snap-in connector prong. The multi-component extrusion includes a primary extrusion profile having an outer surface of a predetermined shape including a mounting face and is formed of a primary extrudate. An exterior capstock layer is formed from a capstock extrudate and is formed over and surrounds at least the mounting face of the primary extrusion profile. At least one prong for a snap-in connector is formed of the capstock extrudate and is attached to the capstock layer attached to the mounting face of the extrusion profile.

### BRIEF DESCRIPTION OF THE DRAWINGS

FIG. 1 is an environmental, isometric view of a preferred embodiment of the inventive multi-component extrusion profile with a male snap-in connector formed from a capstock material.

FIG. 2 is a plan view of a snap-in connector of the inventive multi-component extrusion showing both the male and female portions of the connector.

FIG. 3 is an exploded schematic representation of a plurality of extrusion die plates employed in the manufacture of the extrusion shown in FIG. 1.

FIG. 4 is an isometric view of a mandrel plate that is one of the extrusion die plates of FIG. 3.

FIG. 5 is an isometric view of a representation of the material flow through the conduits and apertures of the extrusion plates of FIG. 3.

### DETAILED DESCRIPTION OF THE PREFERRED EMBODIMENTS

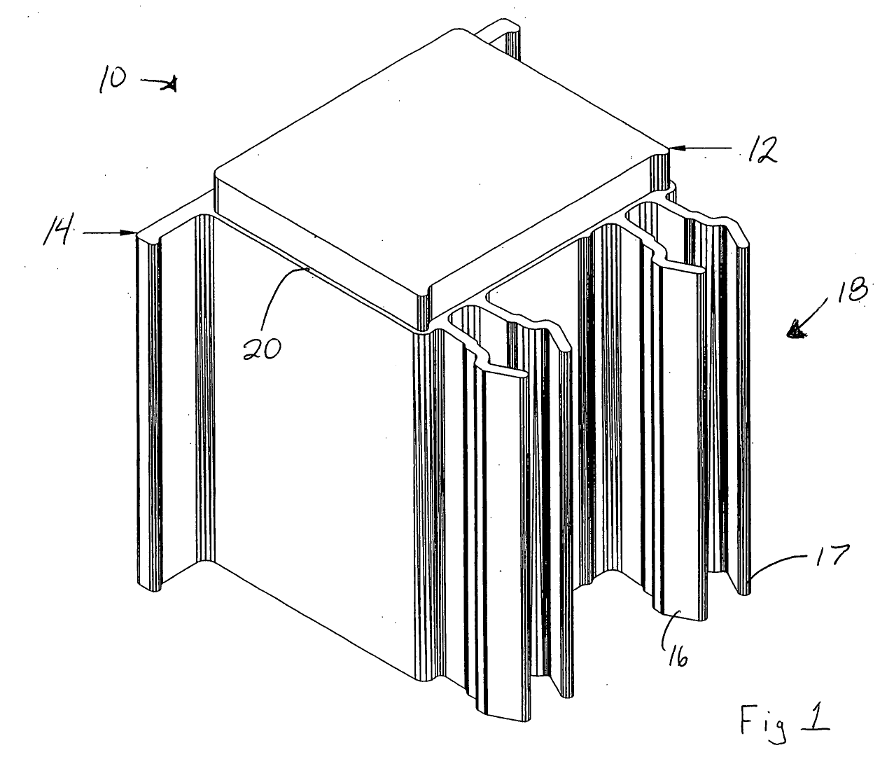

In FIG. 1, a preferred embodiment of the inventive multi-component composite continuously lineal extrusion is generally indicated at reference numeral 10 having a interior foamed portion 12 and a capstock 14 with prongs 16 and 17 of a male portion of the snap-in connector 18. The capstock portion 14 surrounds the entire interior foamed portion 12 and includes male prongs 16 and 17 and surface capstock portion 20. It should be noted that the thickness of the surface capstock portion 20 of the capstock 14 is substantially less than the thickness of the prongs 16 and 17. It should also be noted that the invention disclosed, herein, encompasses the use of a non-foamed thin walled hollow extrusion that replaces the foamed portion 12 in the multi-component extrusion 10.

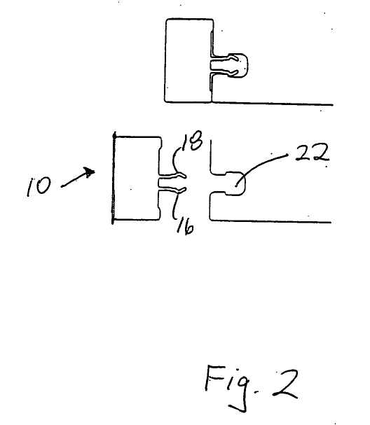

In FIG. 2, an embodiment of the inventive multi-component composite extrusion 10 with the male prongs 16 and 17 of the male snap-in connector 18 is shown with a corresponding female snap-in connector pocket 22. Prong 16 bends inwardly toward prong 17 and prong 17 bends inwardly toward prong 16 as the male connector 18 is inserted into the female connector pocket 22. Each prong 16 and 17 springs outwardly away from the opposite prong 17 and 16 when fully in the recess of the female connector pocket 22 and therefore resist being removed.

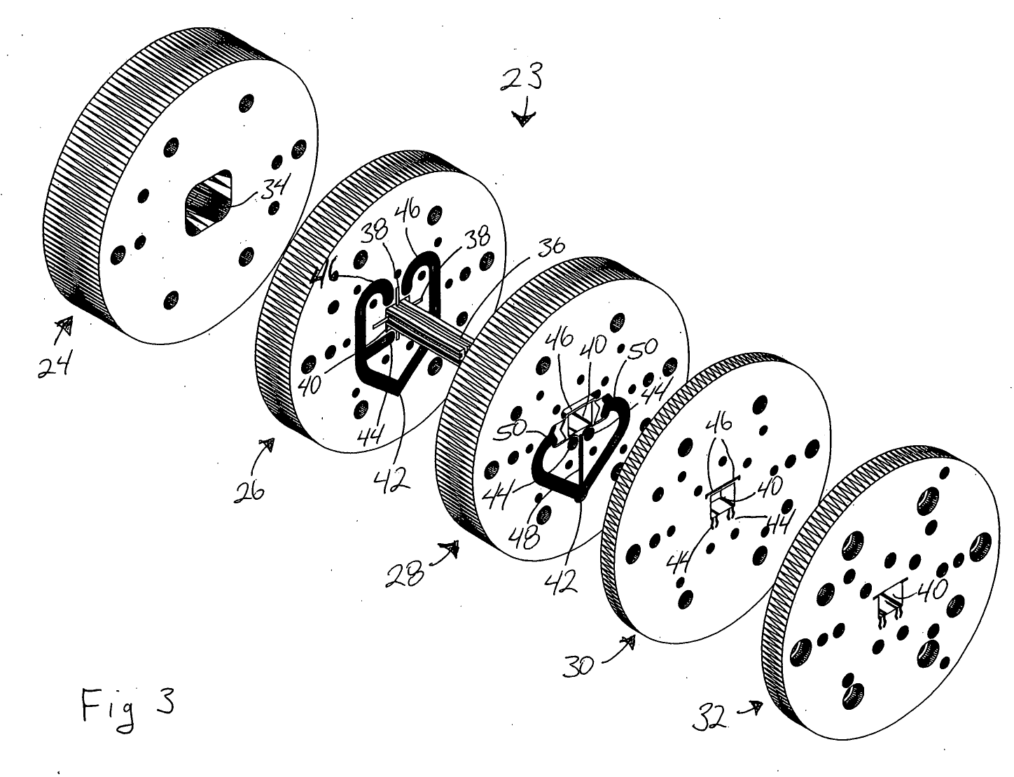

FIG. 3 illustrates a die assembly generally indicated at reference numeral 23 consisting of individual die plates 24, 26, 28, 30, and 32, for manufacturing the inventive multi-component extrusion with a male snap-in connector formed from a capstock material. The manner of use of such dies is well known to those of ordinary skill in the thermoplastic extrusion art and is well described in U.S. patent application Ser. No. 09/452,906, entitled “Wood Fiber Polymer Composite Extrusion and Method” assigned to the assignee of the present invention. Disclosure of that application is incorporated herein by reference. Nevertheless, it is sufficient to state that the die assembly 23 shown in FIG. 3 is intended for use with two conventional extruders, such as conventional twin screw extruders, each of which includes a mixer or hopper for accepting a thermoplastic feed stock material that may or may not include a filler such as wood flour, preferred feed stock materials are disclosed below, a conduit for connecting the hopper with a preheater for controlling the temperature of an admixture of the feed stock in the hopper, and optionally an inlet for introducing foaming agents in the case of a foamed component. The preheater is connected to the screw chamber of each extruder so as to pass the feed stock through to the extruder. The multi-screw chamber of each extruder is connected to an appropriate one of the die assembly plates shown in FIG. 3 for producing the multi-component extrusion with snap-in connector shown in FIG. 1.

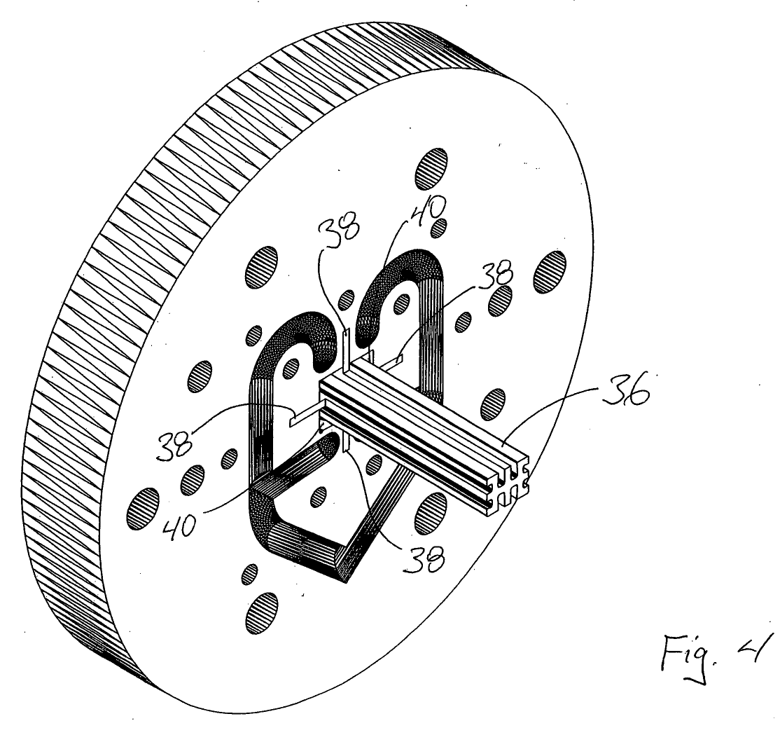

As best seen in FIG. 3, one of the herein above described extruders (not shown) is fluidly connected in a manner well known and understood in the thermoplastic extrusion art to an introductory plate 24 for introduction of a primary extrudate, a suitable formulation of which is disclosed below, through a primary aperture 34. The primary extrudate may be a foamed thermoplastic polymer, a thermoplastic and wood flour composite, a foamed thermoplastic and wood flour composite as is needed or desired by the intended usage or application for the final extruded multi-component extrusion. The herein disclosed invention encompasses a primary extrudate of whatever type or nature where a prong for a snap-in connector is co-extruded with the primary extrudate and the prong is formed from a capstock material. Introductory plate 24 is fluidly connected to a mandrel plate 26 that supports a mandrel 36 by means of a plurality of longitudinally elongated fins 38 within the primary conduit 40. Mandrel plate 26 is broken out and shown in detail in FIG. 4. The primary extrudate flows through the primary aperture 34 into the primary conduit 40 and therein flows in contact with the length of mandrel 36, as the primary conduit 40 extends through mandrel plate 26, first capstock plate 28, second capstock plate 30, and exit die plate 32.

Also shown in FIG. 3 are first and second capstock plates, 28 and 30 respectively, and exit die plate 32. An additional extruder (not shown) as described herein above is fluidly connected out to the bottom of the first capstock plate 28 to a primary capstocking conduit 42. Primary capstocking conduit 42 is fluidly connected to prong capstocking conduits 44, top capstocking conduits 46, base capstocking conduit 48, and side capstocking conduits 50. Prong capstocking conduit 44 and top capstocking conduit 46 continue from mandrel plate 26, through first and second capstock plates 28, 30 and meet with the primary conduit 40 in exit die plate 32. The top capstocking conduit 46 meets with the primary conduit 40 within the exit die plate 32 and the capstocking extrudate meets the primary extrudate with in the exit die for that portion of the multi-component extrusion. The base capstocking conduit 48 and side capstocking conduits 50 feed a thin layer of the capstock material on the primary extrudate flowing in the primary 40 while the materials are within the first capstock plate 28.

Thus the inventive method and extrusion apparatus has the prong capstocking conduit 44 meeting the primary conduit 40 within the exit die plate 30 where the primary extrudate has already been coated with a thin layer of capstocking extrudate by base capstocking conduit 48. Thus, the prongs 16,17 of FIG. 1 are attached to the base capstock layer already attached to the primary extrudate.

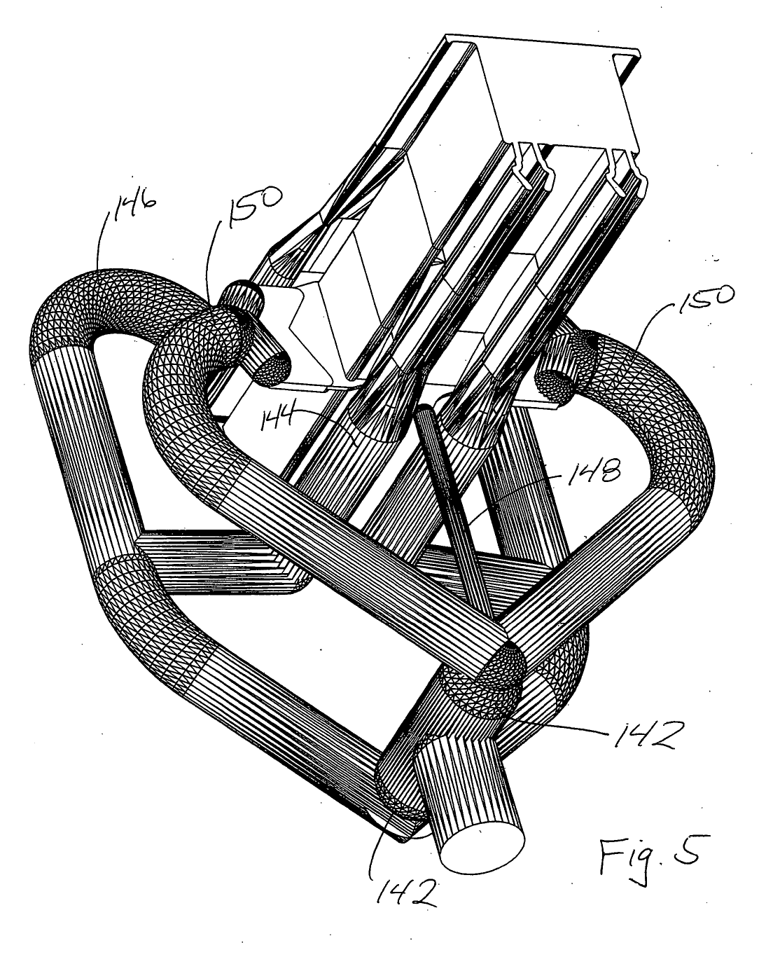

The flow of the primary extrudate and the capstocking extrudate within the capstocking conduits 42, 44, 46, and 48 can be more readily seen in FIG. 5. FIG. 5 is a representation of the flow of the primary extrudate and the capstocking extrudate through the die assembly 23. Primary capstocking conduit material is shown at reference numeral 142. Top capstocking conduit material 146 is fluidly connected to the primary capstocking conduit material 142. Base capstocking conduit material is shown at reference numeral 148.

TABLE I
SAN/Wood Flour Foamed Composite

| | PERCENT | | | |
|---|---|---|---|---|
| | (by | | | |
| INGREDIENT | weight) | SUPPLIER | CITY | STATE |
| SAN Resin | 70-90 | Kumho | | South |
| | | | | Korea |
| Wood Flour | 2-25 | American | Schofield | Wisconsin |
| | | Wood Fiber | | |
| ABS | 2-8 | GE | Morgantown | West |
| Modifier | | | | Virginia |
| Lubricant | 0.1-0.5 | Synpro | Cleveland | Ohio |
| Foaming | 0.5-3.0 | Color Matrix | Cleveland | Ohio |
| Agent | | | | |

Table I discloses a suitable primary extrudate in the form of a foamable SAN and wood flour composite feedstock material. A suitable SAN resin product available from Kumho is “SAN 350.” A suitable wood flour product available from American Wood Fiber is the “4060” product which is a 60 mesh wood flour product (i.e., a product where the largest particle size will sift through a 60 mesh screen). A suitable ABS modifier available from GE is the HR-181 product. A suitable foaming agent available from Color Matrix is the “Foamazol F-92” product.

TABLE II
PVC Capstock Formulation

| | PERCENT | | | |
|---|---|---|---|---|
| | (by | | | |
| INGREDIENT | weight) | SUPPLIER | CITY | STATE |
| PVC Resin | 76.161 | Shintech | Freeport | Texas |
| (SE-650) | | | | |
| Stabilizer | 0.610 | Witco | Taft | Louisiana |
| 401P | 0.228 | PQ | Kansas | Kansas |
| | | Corporation | City | |
| Lubricant | 2.44 | Cognis | Kanakee | Illinois |
| (VGE-3041) | | | | |
| Anti- | 0.38 | Clariant | | Germany |
| static | | | | |
| Modifier | 4.95 | Kaneka | Pasadena | Texas |
| (K-37) | | | | |
| Calcium | 3.04 | OMYA | Florence | Vermont |
| Carbonate | | | | |
| Titanium | 7.62 | Huntsman | Lake | Louisiana |
| Dioxide | | Tioxide | Charles | |
| Calcined | 4.57 | Burgess | Sandersville | Georgia |
| Clay | | | | |

Table II discloses a suitable capstocking extrudate for use in the herein disclosed invention.

We claim:

1. A multi-plate extrusion die for producing a multi-component extrusion having an upstream and a downstream direction, comprising:
a primary aperture extending in the downstream direction for a primary extrudate fed from a primary extruder, the primary extrudate being formed by the primary aperture into substantially a final shape of the multi-component extrusion, the primary extrudate having a prong mounting face and having a non-prong surface,
a base capstocking conduit for a capstocking extrudate
fed from a capstocking extruder where the base capstocking conduit joins with the primary aperture and applies a base capstocking layer on the prong mounting face of the primary extrudate,
a prong capstocking conduit for the capstocking extrudate fed from the capstocking extruder, where the prong capstocking conduit forms a prong and where the prong capstocking conduit joins with the primary aperture downstream of the base capstocking conduit and attaches a base end of the prong to the base capstocking layer on the prong mounting face of the primary extrudate.

2. The multi-plate extrusion die of claim 1, wherein
the base capstocking conduit joins with the primary aperture and applies the capstocking layer on the non-prong portion of the primary extrudate.

3. The multi-plate extrusion die of claim 1, further comprising,
a surface capstocking conduit joins with the primary aperture and applies the capstocking extrudate to the non-prong surface of the primary extrudate.

4. The multi-plate extrusion die of claim 1, wherein the primary extrudate is a thermoplastic resin formed into a hollow, thin walled extrusion.

5. The multi-plate extrusion die of claim 4, wherein the thermoplastic resin is PVC resin.

6. The multi-plate extrusion die of claim 1, wherein the primary extrudate is a foamed thermoplastic resin.

7. The multi-plate extrusion die of claim 6, wherein the thermoplastic resin is a foamed PVC resin.

8. The multi-plate extrusion die of claim 6, wherein the thermoplastic resin is a foamed SAN resin.

9. The multi-plate extrusion die of claim 1, wherein the capstocking extrudate is a PVC resin.

10. A method for producing a multi-component extrusion, comprising:
forming a primary extrudate within a multi-plate extrusion die fed from a primary extruder into a substantially final shape of the multi-component extrusion, such primary extrudate having a prong mounting face and having a non-prong surface,
applying a base capstocking layer of a capstocking extrudate on the prong mounting face of the primary extrudate within the multi-plate extrusion die with a capstocking extruder,
forming a prong within the multi-plate extrusion die of capstocking extrudate from a capstocking extruder,
attaching the prong to the base capstocking layer within the multi-plate extrusion die.

11. The method of claim 10, wherein the primary extrudate is a thermoplastic resin and is formed into a hollow, thin walled extrusion.

12. The method of claim 10, wherein the thermoplastic resin is a PVC resin.

13. The method of claim 10, wherein the primary extrudate is a foamed thermoplastic resin and is formed into a solid extrusion.

14. The method of claim 13, wherein the foamed thermoplastic resin is foamed SAN resin.

15. The method of claim 14, wherein the foamed thermoplastic resin is foamed PVC resin.

16. The method of claim 10, wherein the capstocking extrudate is a PVC resin.

17. The method of claim 10, further comprising applying a capstocking layer of the capstocking extrudate to the non-prong surface of the primary extrudate within the multi-plate extrusion die with the capstocking extruder.

18. A multi-component extrusion having a snap-in connector prong, comprising:
a primary extrudate of a predetermined shape having a prong mounting face and a non-prong surface,
a base capstocking layer formed of a capstocking extrudate on the prong mounting face of the primary extrudate,
a prong for use as a snap-in connector where the prong is formed of the capstocking extrudate and is attached to the base capstocking layer.

19. The multi-component extrusion of claim 18, wherein the primary extrudate is a hollow, thin walled extrusion formed of thermoplastic resin.

20. The multi-component extrusion of claim 19, wherein the thermoplastic resin is a PVC resin.

21. The multi-component extrusion of claim 18, wherein the primary extrudate is a solid foamed extrusion formed from a foamed thermoplastic resin.

22. The multi-component extrusion of claim 21, wherein the foamed thermoplastic resin is foamed SAN resin.

23. The multi-component extrusion of claim 22, wherein the foamed thermoplastic resin is foamed PVC resin.

24. The multi-component extrusion of claim 18, wherein the capstocking extrudate is a PVC resin.

25. The multi-component extrusion of claim 18, further comprising a second prong for use as the snap-in connector where the second prong is formed of the capstocking extrudate and is attached to the base capstocking layer.
